(19) United States
(12) Patent Application Publication
(10) Pub. No.: US 2025/0079853 A1
(43) Pub. Date: Mar. 6, 2025

(54) POWER GENERATING DEVICE AND POWER SUPPLYING METHOD THEREOF

(71) Applicant: National Tsing Hua University, Hsinchu City (TW)

(72) Inventors: Chao-I Liu, Hsinchu City (TW); Heng-An Su, Hsinchu City (TW); I-Chu Lin, Hsinchu City (TW); Yao-Yu Lin, Hsinchu City (TW); Chia-Chieh Hsu, Hsinchu City (TW); Hsin-Tien Li, Hsinchu City (TW); Tzu-Yin Liu, Hsinchu City (TW); Han-Yi Chen, Hsinchu City (TW)

(73) Assignee: National Tsing Hua University, Hsinchu City (TW)

(21) Appl. No.: 18/490,771

(22) Filed: Oct. 20, 2023

(30) Foreign Application Priority Data
Aug. 30, 2023 (TW) 112132799

(51) Int. Cl. H02J 7/00; H02J 7/34; H02J 7/35

(52) U.S. Cl. CPC H02J 7/0013; H02J 7/342; H02J 7/345; H02J 7/35

(57) ABSTRACT

A power generating device and a power supplying method thereof are provided. The power generating device includes a battery set, a charge storage device, a charger and a voltage converter. The battery set has microbial fuel cell and/or solar battery, and is configured to generate a supply voltage. The charger generates a charging voltage according to the supply voltage, and provides the charging voltage through a first resistor to charge the charge storage device. The voltage converter converts a storage voltage provided by the charge storage device to generate a driving voltage, and provides the driving voltage to drive a load.

### CROSS-REFERENCE TO RELATED APPLICATION

This application claims the priority benefit of Taiwan application serial no. 112132799, filed on Aug. 30, 2023. The entirety of the above-mentioned patent application is hereby incorporated by reference herein and made a part of this specification.

### BACKGROUND

### Technical Field

The invention relates to a power generating device and a power supplying method thereof, and particularly relates to a power generating device applied to microbial fuel cells and/or solar cells and a power supplying method thereof.

### Description of Related Art

Along with the rise of environmental awareness, green energy has become an important goal. However, in today's technical field, microbial fuel cells and solar cells have shortcomings such as non-linear output characteristics, insufficient output efficiency, single circuit only suitable for a specific design, etc. Therefore, the microbial fuel cells and solar cells are deficient in practical applications, ease of use, and applicability.

### SUMMARY

The invention is directed to a power generating device and a power supplying method thereof, which enable microbial fuel cells and solar cells to effectively provide a driving voltage to drive a load.

The invention provides a power generating device including a battery set, a charge storage device, a charger and a voltage converter. The battery set has a microbial fuel cell and/or a solar cell, and is configured to generate a supply voltage. The charger is coupled to the battery set and the charge storage device. The charger generates a charging voltage according to the supply voltage to charge the charge storage device, wherein the charger provides the charging voltage through a first resistor. The voltage converter is coupled to the charge storage device, converts a storage voltage provided by the charge storage device to generate a driving voltage, and provides the driving voltage to drive a load.

The invention provides a power supplying method including: providing a battery set to generate a supply voltage, wherein the battery set has at least one microbial fuel cell and/or at least one solar cell; providing a charger to receive the supply voltage through a first resistor, and enabling the charger to generate a charging voltage according to the supply voltage to charge a charge storage device; and providing a voltage converter to convert a storage voltage provided by the charge storage device to generate a driving voltage, and providing the driving voltage to drive a load.

Based on the above, the invention charges the charge storage device by using the supply voltage generated by the battery set having at least one microbial fuel cell and/or at least one solar cell. Then, the driving voltage for driving the load is generated by converting the storage voltage in the charge storage device. In this way, the microbial fuel cell and the solar cell do not need to directly drive the load. Instead, the charges are first stored in the charge storage device that may provide stable supply power, and the charge storage device is used to provide the storage voltage to generate the driving voltage. The voltage converter may be configured to adjust a voltage value of the driving voltage so that the driving voltage may effectively drive the load.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a power generating device according to an embodiment of the invention.

FIG. 2 is a system framework diagram of a power generating device according to an embodiment of the invention.

FIG. 3A to FIG. 3D are schematic circuit diagrams of a power generating device according to the embodiment of the invention.

FIG. 4 is a schematic diagram of a power generating device according to another embodiment of the invention.

FIG. 5 and FIG. 6 are respectively circuit diagrams of different implementations of a power generating device according to another embodiment of the invention.

FIG. 7 is a flowchart of a power supplying method according to an embodiment of the invention.

FIG. 8 is a schematic diagram of a microbial fuel cell according to a first embodiment of the invention.

FIG. 9 is a schematic diagram of a plant microbial fuel cell according to a second embodiment of the invention.

### DESCRIPTION OF THE EMBODIMENTS

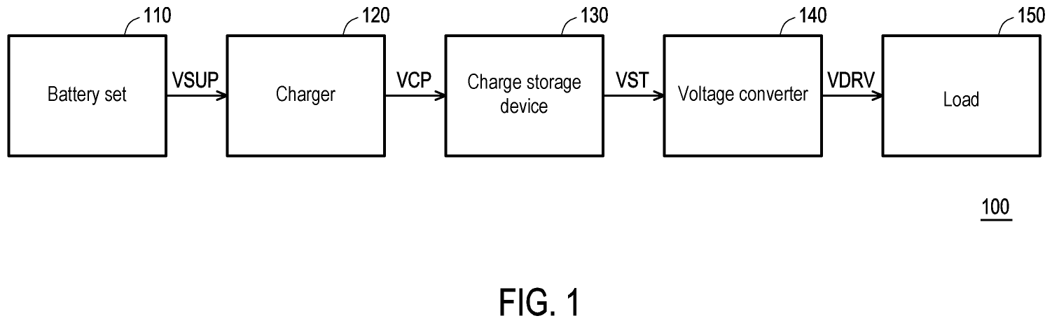

Referring to FIG. 1. FIG. 1 is a schematic diagram of a power generating device according to an embodiment of the invention. A power generating device 100 includes a battery set 110, a charger 120, a charge storage device 130 and a voltage converter 140. The battery set 110 has at least one of one or a plurality of microbial fuel cells and one or a plurality of solar cells, and is configured to generate a supply voltage VSUP. The microbial fuel cells (MFCs) may also be plant microbial fuel cells (PMFCs). The microbial fuel cells are configured to convert chemical energy into electrical energy and generate the supply voltage VSUP. In addition, the microbial fuel cells and solar cells in the battery set 110 may be constructed in an N parallel and M series manner, where N and M are arbitrary positive integers without specific limitations. The battery set 110 is configured to generate the supply voltage VSUP.

The charger 120 is coupled between the battery set 110 and the charge storage device 130. The charger 120 receives the supply voltage VSUP generated by the battery set 110 and generates a charging voltage VCP according to the supply voltage VSUP to charge the charge storage device 130. In the embodiment of the invention, compared to the microbial fuel cells and solar cells, the charge storage device 130 may have a relatively stable power supply capability and may provide a relatively large driving current. In the embodiment of the invention, the charge storage device 130 may be any form of rechargeable battery (such as a lithium battery, a nickel metal hydride battery, etc.), or may also be a supercapacitor.

It should be noted that in the embodiment of the invention, the charger 120 may provide the charging voltage VCP through a first resistor. As the microbial fuel cells and solar cells have relatively low output efficiencies, if the supply voltage VSUP of the battery set 110 outputs an excessive current, the supply voltage VSUP will drop rapidly, which may prevent the charger 120 from working properly. Therefore, in the embodiment of the invention, by setting the first resistor in the charger 120 and supplying the charging voltage through the first resistor, the output current of the supply voltage VSUP may be limited, which ensures that the charging operation of the charger 120 may be performed normally.

In addition, the voltage converter 140 is coupled to the charge storage device 130. The voltage converter 140 receives a storage voltage VST provided by the charge storage device 130 and converts the storage voltage VST provided by the charge storage device 130 to generate a driving voltage VDRV. The voltage converter 140 is further coupled to the load 150 and provides the driving voltage VDRV to drive the load 150. The storage voltage VST provided by the charge storage device 130 may be a direct current (DC) voltage, and the voltage converter 140 may be a DC to DC voltage converter. In order to meet a driving requirement of the load 150, the voltage converter 140 may be a booster DC-to-DC voltage converter configured to increase a voltage value of the storage voltage VST to generate the driving voltage VDRV.

The power generating device 100 in the embodiment of the invention transfers the electric energy in the battery set 110 to the charge storage device 130, and the charge storage device 130 provides the storage voltage VST with stable output capability to the voltage converter 140. In this way, the voltage converter 140 may generate the driving voltage VDRV with the same stable output capability to drive the load 150 and enable the load 150 to operate normally.

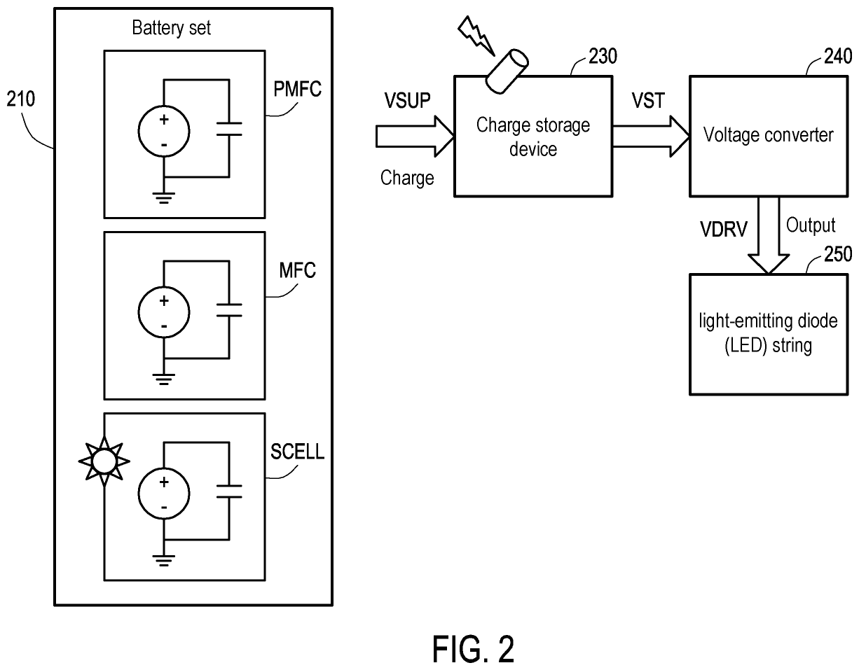

Referring to FIG. 2 below, FIG. 2 is a system framework diagram of a power generating device according to an embodiment of the invention. A power generating device 200 includes a battery set 210, a charge storage device 230 and a voltage converter 240. Where, the battery set 210 may have at least one of a microbial fuel cell MFC, a plant microbial fuel cell PMFC, and a solar cell SCELL. In the battery set 210, the number of the microbial fuel cells MFC, the plant microbial fuel cells PMFC, and the number of the solar cells SCELL may be respectively one or plural without specific limitation.

The power generating device 200 may use the supply voltage VSUP generated by the battery set 210 to charge the charge storage device 230. On the other hand, the charge storage device 230 may provide the storage voltage VST to the voltage converter 240, and the voltage converter 240 may convert the storage voltage VST to generate the driving voltage VDRV through a boost conversion operation. The voltage converter 240 may provide the generated driving voltage VDRV to drive a light-emitting diode (LED) string 250 (load) and light up the LED string 250.

In the embodiment, the voltage converter 240 may perform a boosting operation of the storage voltage VST according to a demand voltage for driving the LED string 250, and the generated driving voltage VDRV may be greater than or equal to the above-mentioned demand voltage. In an embodiment of the invention, the voltage converter 240 may also adjust a brightness of the LED string 250 by adjusting a voltage value of the generated driving voltage VDRV. Alternatively, in other embodiments of the invention, the LED string 250 may also be additionally coupled to a control circuit (not shown), and the control circuit may adjust the driving capability of the driving voltage VDRV through at least one of a pulse-width modulation (PWM) mechanism and a pulse-amplitude modulation (PAM) mechanism, and accordingly adjust a luminous brightness of the LED string 250.

Regarding a circuit framework of the voltage converter 240, the voltage converter 240 in the embodiment of the invention may be implemented by using any boost-type DC-to-DC voltage conversion circuit well known to those skilled in the art, without certain limitations.

It should be noted that in the embodiment of the invention, the charging operation performed on the charge storage device 230 and the voltage conversion operation performed by the voltage converter 240 may be two independent operations. Where, the voltage conversion operation of the voltage converter 240 may be performed when the charge storage device 230 has sufficient electric energy. The charging operation performed on the charge storage device 230 may be performed according to a power supply status of the microbial fuel cell MFC, the plant microbial fuel cell PMFC, and the solar cell SCELL, and is not related to the voltage conversion operation of the voltage converter 240.

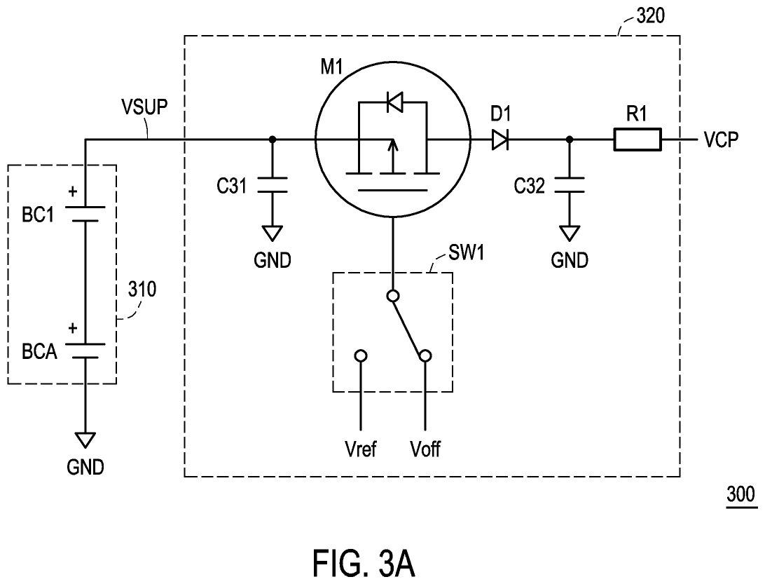

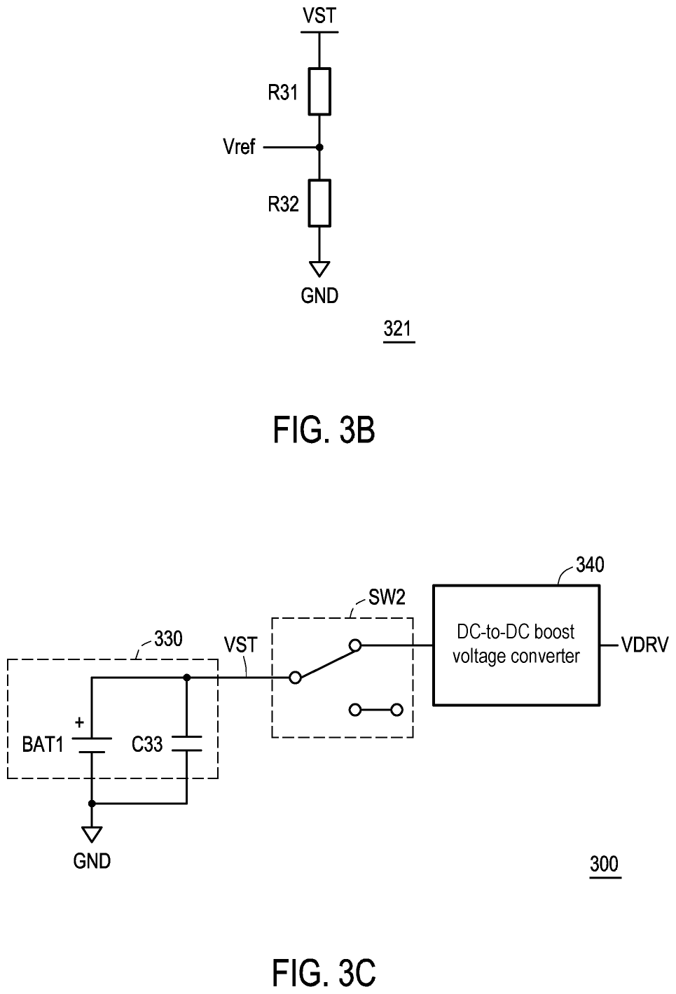

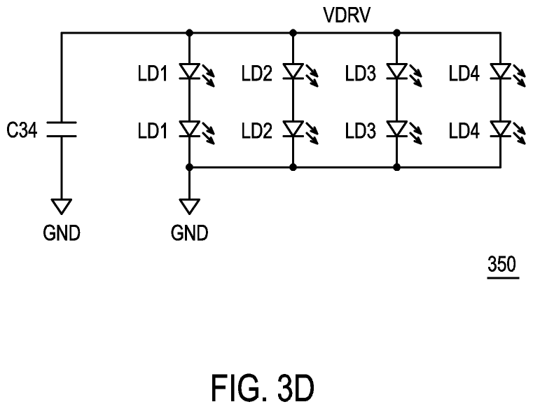

Referring to FIG. 3A to FIG. 3D. FIG. 3A to FIG. 3D are schematic circuit diagrams of a power generating device according to the embodiment of the invention. FIG. 3A is a schematic circuit diagram of a battery set 310 and a charger 320 of a power generating device 300. The battery set 310 includes a plurality of battery cells BC1 to BCA. The battery cells BC1-BCA may be coupled between the charger 320 and a reference voltage terminal GND, and generate the supply voltage VSUP. Where, the reference voltage terminal GND may be a reference ground terminal.

In addition, the charger 320 is coupled to the battery set 310 and receives the supply voltage VSUP. The charger 320 includes a transistor M1, capacitors C31, C32, a resistor R1, a diode D1 and a switch SW1. A first terminal of the transistor M1 receives the supply voltage VSUP; a control terminal of the transistor M1 is coupled to the switch SW1; and a second terminal of the transistor M1 is coupled to an anode of the diode D1. In addition, a cathode of the diode D1 is coupled to a first terminal of the resistor R1. A second terminal of the resistor R1 is an output terminal of the charger 320 and is configured to generate the charging voltage VCP. In addition, the capacitor C31 is coupled between the first terminal of the transistor M1 and the reference voltage terminal GND, and the capacitor C32 is coupled between the cathode of the diode D1 and the reference voltage terminal GND. In the embodiment, the transistor M1 may be a P-type transistor.

In the embodiment, the diode D1 is used as a current direction limiting element to limit a direction of a current in the charger 320 to be from the first terminal of the transistor M1 to the second terminal of the transistor M1. Therefore, when a voltage on the output terminal of the charger 320 (which may be equal to the storage voltage of the charge storage device) is greater than the supply voltage VSP, a phenomenon of the charge storage device discharging the charger 320 will not occur. The capacitors C31 and C32 are voltage stabilizing capacitors.

It should be noted that the switch SW1 receives a control voltage Vref and a cut-off voltage Voff, and through a switching operation, the control terminal of the transistor M1 receives the control voltage Vref or the cut-off voltage Voff. When the charger 320 performs a charging operation, the switch SW1 may select the control voltage Vref to transmit to the control terminal of the transistor M1, so that the transistor M1 may be appropriately turned on according to the control voltage Vref. In contrast, when the charger 320 does not perform the charging operation, the switch SW1 may select the cut-off voltage Voff to transmit to the control terminal of the transistor M1 to turn off the transistor M1. The cut-off voltage Voff is a preset voltage that may turn off the transistor M1.

In the embodiment, the control operation of the switch SW1 may be controlled by an external electronic device. The external electronic device may perform the control operation of the switch SW1 according to a working state of the system corresponding to the power generating device 300.

According to FIG. 3B, the control voltage Vref may be provided by a control voltage generator 321. The control voltage generator 321 includes resistors R31 and R32. The resistors R31 and R32 are connected in series between the storage voltage VST and the reference voltage terminal GND. The resistors R31 and R32 divide the storage voltage VST to generate the control voltage Vref.

Regarding the operation details of the charger 320, when the charger 320 performs the charging operation, taking the storage voltage VST in an initial state as having a relatively low voltage as an example, in the initial state, the control voltage Vref may have a relatively low voltage value, causing the transistor M1 to be turned on. The turned-on transistor M1 may provide the supply voltage VSUP generated by the battery set 310 to generate the charging voltage VCP through the diode D1 and the resistor R1, and charge the charge storage device of a subsequent stage.

As the charging operation proceeds, the voltage value of the storage voltage VST may gradually increase, and the control voltage Vref also increases accordingly. As the control voltage Vref increases, a conduction degree of the transistor M1 accordingly decreases. When the charging operation of the charge storage device is completed, the storage voltage VST rises to a sufficiently high voltage value, and the correspondingly generated control voltage Vref may turn off the transistor M1, and end the charging operation.

It should be noted that the resistor R1 serves as a current limiting resistor for the supply voltage VSUP. In other embodiments of the invention, the resistor R1 may also be coupled between the diode D1 and the transistor M1.

FIG. 3C is a schematic circuit diagram of a charge storage device 330, a switch SW2 and a DC-to-DC boost voltage converter 340 of the power generating device 300. The charge storage device 330 includes a battery BAT and a capacitor C33. The battery BAT and the capacitor C33 are coupled in parallel with each other. The battery BAT is a rechargeable battery, such as a rechargeable nickel-metal hydride battery or lithium battery. The charge storage device 330 is coupled to the DC-to-DC boost voltage converter 340 through the switch SW2.

Through the switching operation of the switch SW2, the charge storage device 330 may be coupled to the DC-to-DC boost voltage converter 340 and provide the storage voltage VST to the DC-to-DC boost voltage converter 340. The DC-to-DC boost voltage converter 340 performs a boost conversion operation according to the storage voltage VST to generate the driving voltage VDRV.

In FIG. 3D, the driving voltage VDRV is transmitted to a load 350. The load 350 includes a plurality of LED strings formed by a plurality of LEDs LD1-LD4. Where, the plurality of LEDs LD1, LD2, LD3, and LD4 respectively form a plurality of LED strings, and emit light according to the driving voltage VDRV. In the embodiment, the load 350 further includes a capacitor C34. The capacitor C34 is coupled between the driving voltage VDRV and the reference voltage terminal GND to serve as a voltage stabilizing capacitor.

Referring to FIG. 3C again, when the power generating device 300 stops driving the load 350, the switch SW2 may be switched to cut off the coupling relationship between the charge storage device 330 and the DC-to-DC boost voltage converter 340. In this way, the DC-to-DC boost voltage converter 340 may stop generating the driving voltage VDRV.

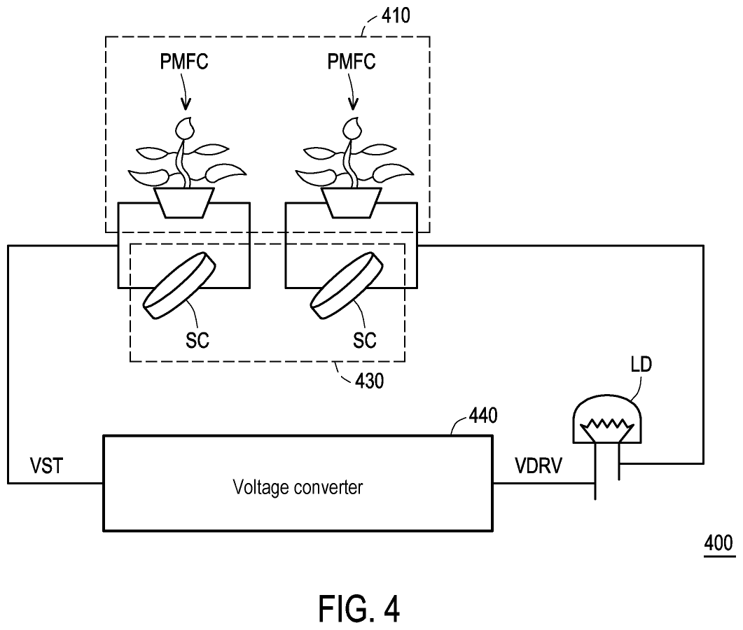

Referring to FIG. 4 below. FIG. 4 is a schematic diagram of a power generating device according to another embodiment of the invention. A power generating device 400 includes a battery set 410, a charge storage device 430, and a voltage converter 440. The battery set 410 includes a plurality of plant microbial fuel cells PMFCs connected in series. The charge storage device 430 includes a plurality of supercapacitors SC coupled in series. Where, the supercapacitor SC and the corresponding plant microbial fuel cell PMFC are coupled in parallel with each other.

In the embodiment, the plant microbial fuel cells PMFC may also be replaced by microbial fuel cells or solar cells, without specific limitations. There are also no specific limitations on the number of the plant microbial fuel cells PMFC in the battery set 410 and the number of the supercapacitors SC in the charge storage device 430. The number of two shown in FIG. 4 is only an example for illustration and is not intended to limit the scope of the invention.

The battery set 410 is coupled to the charge storage device 430 and charges the charge storage device 430. In addition, the charge storage device 430 is coupled to the voltage converter 440 and provides the storage voltage VST to the voltage converter 440. The voltage converter 440 is a boost DC-to-DC voltage converter, which is configured to convert the storage voltage VST into the driving voltage VDRV, and provide the driving voltage VDRV to drive the LED LD serving as the load.

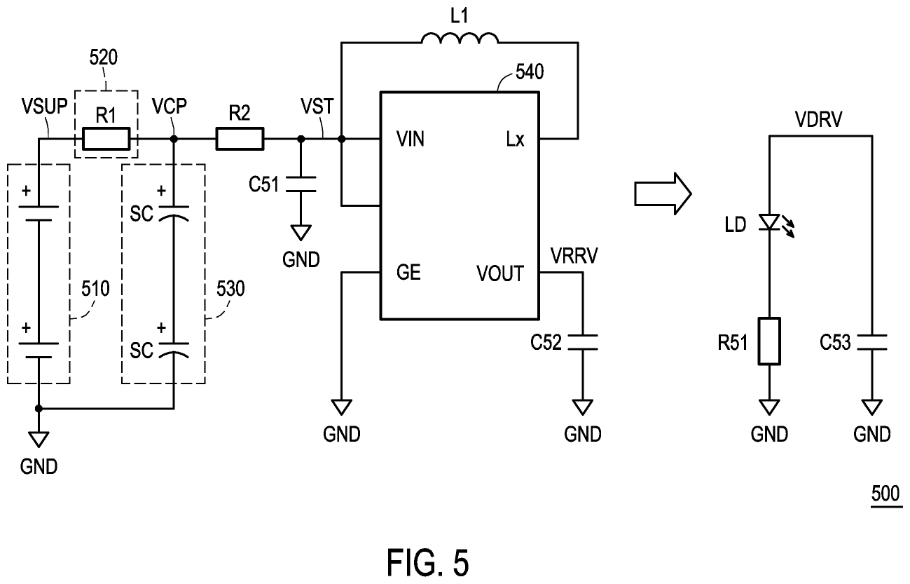

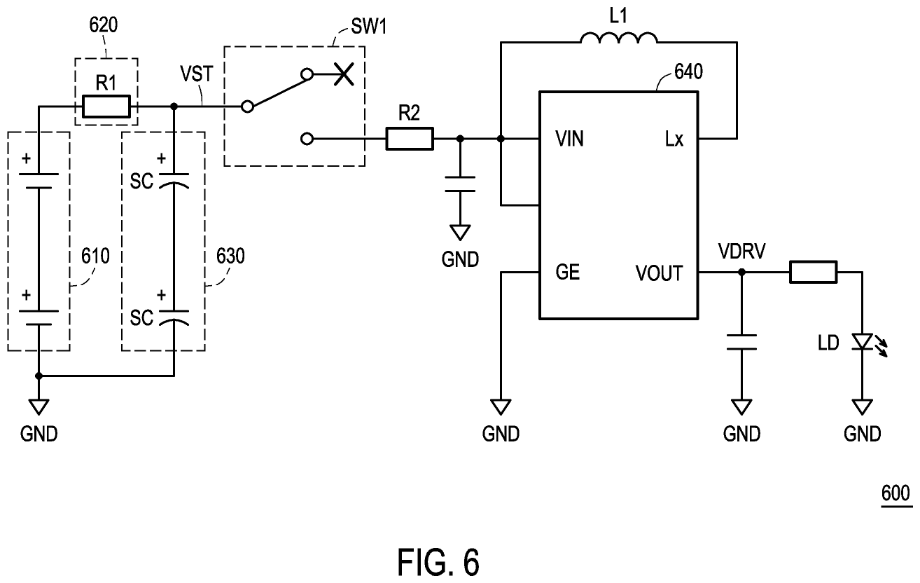

Referring to FIG. 5 and FIG. 6 below, FIG. 5 and FIG. 6 are respectively circuit diagrams of different implementations of a power generating device according to another embodiment of the invention. In FIG. 5, a power generating device 500 includes a battery set 510, a charger 520, a charge storage device 530 and a voltage converter 540. The battery set 510 includes one or a plurality of batteries. The batteries of the battery set 510 may be microbial fuel cells, solar cells, or a combination of the microbial fuel cells and the solar cells. The battery set 510 is configured to generate the supply voltage VSUP. The charger 520 is coupled between the battery set 510 and the charge storage device 530. In the embodiment, the charger 520 includes a resistor R1 to limit a current of the supply voltage VSUP and provide the charging voltage VCP to the charge storage device 530.

The charge storage device 530 includes a plurality of supercapacitors SC, where the supercapacitors SC may be connected in series between the charger 520 and the reference voltage terminal GND. The supercapacitor SC receives the charging voltage VCP and charges according to the charging voltage VCP.

In the embodiment, the charge storage device 530 further provides the storage voltage VST to the voltage converter 540 through the resistor R2. A node where the resistor R2 is coupled to the voltage converter 540 may have a capacitor C51 coupled to the reference voltage terminal GND. The capacitor C51 may be used as a voltage stabilizing capacitor. The voltage converter 540 has a voltage receiving terminal VIN, an inductor terminal Lx, a ground terminal GE, and an output terminal VOUT. The voltage receiving terminal VIN of the voltage converter 540 is coupled to the resistor R2 and receives the storage voltage VST. An inductor L1 is coupled between the voltage receiving terminal VIN and the inductor terminal Lx of the voltage converter 540. The ground terminal GE of the voltage converter 540 is coupled to the reference voltage terminal GND, where the reference voltage terminal GND may be a reference ground terminal. The output terminal VOUT of the voltage converter 540 is coupled to a capacitor C52 and generates the driving voltage VDRV. Where, the capacitor C52 may be used as an energy storage capacitor.

In the embodiment, the driving voltage VDRV may be provided to the LED LD serving as a load. The LED LD may be coupled to a capacitor C53 and a resistor R51. The capacitor C53 may be used as a voltage stabilizing capacitor, and the resistor R51 may be used as a current-limiting resistor to prevent the light-emitting diode LD from being burned due to overcurrent.

In FIG. 6, the power generating device 600 includes a battery set 610, a charger 620, a charge storage device 630, a switch SW1 and a voltage converter 640. A circuit framework of the power generating device 600 is substantially the same as that of the power generating device 500 described above, and the same parts will not be described again. Different from the power generating device 500, the power generating device 600 further has a switch SW1. The switch SW1 is coupled between the charge storage device 630 and the resistor R2. When the power generating device 600 is to perform a voltage supply operation, the switch SW1 may couple the charge storage device 630 to the resistor R2 through a switching operation, and provide the storage voltage VST to the voltage input terminal VIN of the voltage converter through the resistor R2. In contrast, when the power generating device 600 wants to stop the voltage supply operation, the switch SW1 may perform a switching operation and cut off the connection between the charge storage device 630 and the resistor R2. In this case, the voltage converter 640 does not receive the storage voltage VST and does not generate the driving voltage VDRV.

The switching operation of the switch SW1 may be controlled by an external electronic device. The external electronic device may control the switch SW1 according to an actual demand of the system.

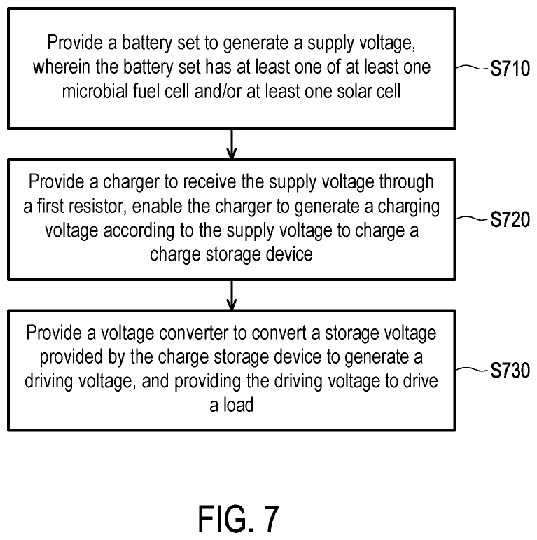

Referring to FIG. 7 below, FIG. 7 is a flowchart of a power supplying method according to an embodiment of the invention. In step S710, a battery set is provided to generate a supply voltage, where the battery set has at least one of at least one microbial fuel cell and at least one solar cell. In step S720, a charger is provided to receive the supply voltage through a first resistor, and the charger generates a charging voltage according to the supply voltage to charge a charge storage device. In step S730, a voltage converter is provided to convert the storage voltage provided by the charge storage device to generate a driving voltage, and provide the driving voltage to drive a load.

The implementation details of the above steps have been described in detail in the foregoing embodiments and implementations, and will not be repeated here.

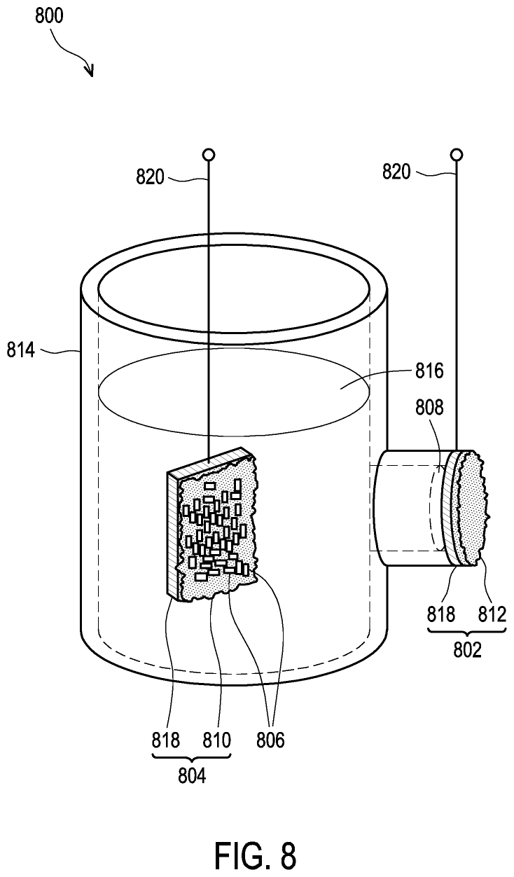

Referring to FIG. 8. FIG. 8 is a schematic diagram of a microbial fuel cell according to a first embodiment of the invention. A microbial fuel cell 800 of the embodiment includes a positive electrode 802, a negative electrode 804 and a microbial group 806. In addition, a proton exchange membrane 808 is disposed between the positive electrode 802 and the negative electrode 804 and located adjacent to the positive electrode 802. However, the invention is not limited thereto. In another embodiment of the microbial fuel cell, it is unnecessary to configure the proton exchange membrane 808. At least one of the positive electrode 802 and the negative electrode 804 includes biocarbon 810 prepared from Trapa natans husks to serve as an electrode material. In the embodiment, the negative electrode 804 includes the biocarbon 810 prepared from waste Trapa natans husks; and the positive electrode 802 adopts activated carbon 812, such as carbon nanotubes, commercial activated carbon, or activated carbon prepared from other waste recycling).

Referring to FIG. 8, the microbial group 806 is located between the positive electrode 802 and the negative electrode 804, and the negative electrode 804 is located in the microbial group 806. Preferably, the microbial group 806 is attached to a surface of the negative electrode 804. The microbial group 806 may be adapted to various single microbial systems, such as Escherichia coli (E. coli), Shewanella putrefaciens, etc., or a diverse microbial system in wastewater sludge. Moreover, a container 814 is usually used to load a liquid 816 containing the microbial group and organic matter or a solid containing organic matter, and the microbial group in the liquid 816 is adsorbed on the surface of the negative electrode 804, and the organic matter in the liquid 816 may react with the microbial group 806. Furthermore, the positive electrode 802 and the negative electrode 804 usually have a conductive plate 818 respectively, and the activated carbon 812 and the biocarbon 810 are respectively coated on the conductive plates 818, where the conductive plate 818 is, for example, carbon cloth, graphite felt, carbon felt, graphite paper, carbon paper, graphite brush, carbon brush, stainless steel mesh or foamed nickel.

In FIG. 8, the microbial group 806 attached to the surface of the biocarbon 810 will take place a metabolic reaction with the organic matter in the liquid 816 to release carbon dioxide, protons and electrons, where the electrons are transferred to the positive electrode 802 through an external circuit 820 to form an electric current and supply power to an external device (not shown), and the protons reach the positive electrode 102 through the proton exchange membrane 808. The electrons and the protons combine with external oxygen at the positive electrode 802 to form water.

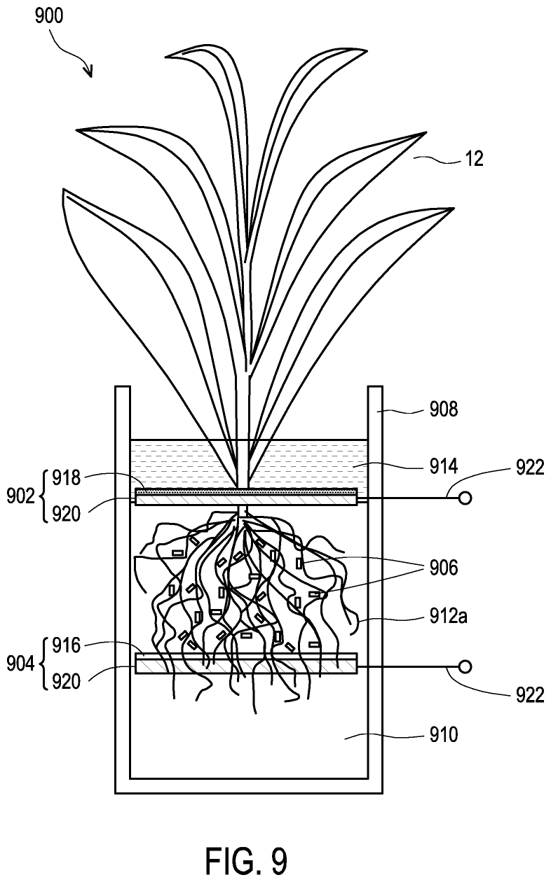

FIG. 9 is a schematic diagram of a plant microbial fuel cell according to a second embodiment of the invention. Referring to FIG. 9, the plant microbial fuel cell 900 of the embodiment includes a positive electrode 902, a negative electrode 904, a microbial group 906, a soil 910 placed in a container 908, and a plant 912 planted in the soil 910, and the microbial group 906 generally exists within the soil 910. In the embodiment, water 914 may be added to the container 908, where a water surface is higher than the soil 910 so that the positive electrode 902 is disposed at a junction of the soil 910 and the water 914, and the negative electrode 904 is disposed around roots 912a of the plant 912. At least one of the positive electrode 902 and the negative electrode 904 includes biocarbon 916 prepared from Trapa natans husks to serve as an electrode material. In the embodiment, the negative electrode 904 includes the biocarbon 916 prepared from waste Trapa natans husks; and the positive electrode 902 adopts activated carbon 918, such as carbon nanotubes, commercial activated carbon, or activated carbon prepared from other waste recycling.

Referring to FIG. 9, the positive electrode 902 and the negative electrode 904 usually have a conductive plate 920 respectively, where the conductive plate 920 is, for example, carbon cloth, graphite felt, carbon felt, graphite paper, carbon paper, graphite brush, carbon brush, stainless steel mesh or foamed nickel. The activated carbon 918 and the biocarbon 916 are respectively coated on the conductive plates 920. For example, activated carbon 918 is coated on the side in contact with water 914, and the biocarbon 916 is coated on the side facing the positive electrode 902. However, the invention is not limited thereto. The activated carbon 918 and the biocarbon 916 may also be coated on all surfaces of each conductive plate 920. In addition, in the embodiment, the positive electrode 902 and the negative electrode 904 may be respectively connected to an external device (not shown) through a metal wire 922, such as a copper wire, an aluminum wire, a silver wire, a gold wire, a titanium wire, etc.

In FIG. 9, nutrients produced by photosynthesis of the plant 912 may be released into the soil 910 through the roots 912a of the plant 912. The microbial group 906 located around the roots 912a may produce electrons in a reaction of decomposing the nutrients containing sugar, and current is collected by the positive electrode 902 and the negative electrode 904 and transmitted to an external device (such as an energy storage device).

In summary, the power generating device of the invention transfers the supply voltage generated by the battery set constructed of the microbial fuel cells and the solar cells to the charge storage device. The charge storage device is then used to provide input power to the voltage converter, and the voltage converter generates the stable driving voltage to drive the load. In this way, the driving operation of the load will not be affected by the nonlinear output characteristics and insufficient output efficiency of the microbial fuel cells and the solar cells, and may operate normally, which effectively improves feasibility of the microbial fuel cells and the solar cells in practical applications and achieve the goal of green energy. In addition, the power generating device of the invention is suitable for both of the microbial fuel cells and the solar cells, which may greatly improve the convenience of use.

What is claimed is:

1. A power generating device, comprising:
a battery set, having at least one of at least one microbial fuel cell and at least one solar cell, and configured to generate a supply voltage;
a charge storage device;
a charger, coupled to the battery set and the charge storage device, and generating a charging voltage according to the supply voltage to charge the charge storage device, wherein the charger provides the charging voltage through a first resistor; and
a voltage converter, coupled to the charge storage device, converting a storage voltage provided by the charge storage device to generate a driving voltage, and providing the driving voltage to drive a load.

2. The power generating device as claimed in claim 1, wherein the first resistor is configured to limit an output current of the supply voltage.

3. The power generating device as claimed in claim 1, wherein the charger comprises:
a control voltage generator, generating a control voltage according to the storage voltage;
a transistor, having a first terminal receiving the supply voltage, a second terminal coupled to the charge storage device to provide the charging voltage, and a control terminal receiving the control voltage; and
the resistor, coupled between a coupling path of the second terminal of the transistor and the charge storage device.

4. The power generating device as claimed in claim 3, wherein the charge storage device is a rechargeable battery.

5. The power generating device as claimed in claim 4, wherein the charger further comprises:
a diode, having an anode coupled to the second terminal of the transistor, and a cathode coupled to the charge storage device;
a first capacitor, coupled between the first terminal of the transistor and a reference voltage terminal; and
a second capacitor, coupled between the second terminal of the transistor and the reference voltage terminal.

6. The power generating device as claimed in claim 4, wherein the charger further comprises:
a switch, coupled between the control terminal of the transistor and the control voltage generator, and enabling the control terminal of the transistor to receive the control voltage or a cut-off voltage.

7. The power generating device as claimed in claim 3, wherein the control voltage generator is a voltage divider that divides the storage voltage to generate the control voltage.

8. The power generating device as claimed in claim 3, wherein the charge storage device is at least one supercapacitor.

9. The power generating device as claimed in claim 8, wherein the charger comprises:
the first resistor, coupled between the at least one supercapacitor and the battery set.

10. The power generating device as claimed in claim 9, further comprising:
a second resistor, coupled between a coupling path of the charge storage device and the voltage converter.

11. The power generating device as claimed in claim 9, wherein the voltage converter is a DC-to-DC boost voltage converter.

12. The power generating device as claimed in claim 1, further comprising:
a switch, coupled between a coupling path of the charge storage device and the voltage converter, and configured to cut off or enable a connection relationship between the charge storage device and the voltage converter.

13. The power generating device as claimed in claim 1, wherein the load is at least one light-emitting diode string.

14. A power supplying method, comprising:
providing a battery set to generate a supply voltage, wherein the battery set has at least one of at least one microbial fuel cell and at least one solar cell;
providing a charger to receive the supply voltage, enabling the charger to generate a charging voltage according to the supply voltage, and providing the charging voltage through a first resistor to charge a charge storage device; and
providing a voltage converter to convert a storage voltage provided by the charge storage device to generate a driving voltage, and providing the driving voltage to drive a load.

15. The power supplying method as claimed in claim 14, wherein the step of providing the charger to receive the supply voltage through the first resistor comprises:
limiting an output current of the supply voltage through the first resistor.

16. The power supplying method as claimed in claim 14, wherein the charge storage device is a rechargeable battery or at least one supercapacitor.

17. The power supplying method as claimed in claim 14, wherein the step of providing the voltage converter to convert the storage voltage provided by the charge storage device to generate the driving voltage comprises:
boosting the storage voltage to generate the driving voltage.
